(19) United States
(12) Patent Application Publication
(10) Pub. No.: US 2026/0073633 A1
(43) Pub. Date: Mar. 12, 2026

(54) OPTIMIZING ENVIRONMENT MAPPING WITH DEPTH PREDICTION

(71) Applicant: Field AI, Inc., Mission Viejo, CA (US)

(72) Inventors: Chanyoung CHUNG, Santa Ana, CA (US); Amirreza SHABAN, Seattle, WA (US)

(73) Assignee: Field AI, Inc., Mission Viejo, CA (US)

(21) Appl. No.: 19/318,582

(22) Filed: Sep. 4, 2025

Related U.S. Application Data
(60) Provisional application No. 63/691,340, filed on Sep. 6, 2024.

(51) Int. Cl. G06T 17/05; G06V 20/70

(52) U.S. Cl. CPC G06T 17/05; G06V 20/70; G06V 2201/07

(57) ABSTRACT

A method of and system for generating a three-dimensional map of an environment can include obtaining a first visual data set, generating a depth prior based on the first visual data set, refining a depth prediction model based on the depth prior, generating a layout based on a refined depth prediction model, and constructing a continuous three-dimensional map of the environment based on the layout and aggregated depth measurements. The visual data set can include visual imagery data and depth data. The depth prior can include geometric cues and semantic cues

### CROSS-REFERENCE TO RELATED APPLICATION

This application claims priority to and the benefit of the filing date of provisional U.S. Patent Application No. 63/691,340, entitled “SYSTEM AND METHOD FOR OPTIMIZING INDOOR ENVIRONMENT MAPPING WITH DEPTH PREDICTION” and filed on Sep. 6, 2024, the entire contents of which is hereby expressly incorporated herein by reference.

### TECHNICAL FIELD

The embodiments of the present disclosure relate to environment mapping, and specifically to systems and methods for generating a three-dimensional map of an environment.

### BACKGROUND

Accurate mapping and reconstructing a layout of environments can be beneficial for a wide range of applications, including building management, security, maintenance, and autonomous robotics. Methods of layout reconstruction can involve manual surveying and blueprint analysis, which are time-consuming and prone to human error.

Some indoor mapping systems primarily rely on a variety of one or more sensors to capture detailed spatial data. One or more Light Detection and Ranging (LiDAR) sensors, in particular, have been used for depth measurement due to their high accuracy in detecting distances. The one or more LiDAR sensors emit laser beams and measure time for a light to bounce back, creating precise three-dimensional maps of an environment. However, while highly effective, LiDAR systems are expensive, require significant power, and are bulky, limiting their use in cost-sensitive and space-constrained applications.

One way to address the limitations of existing systems is by leveraging prior information, such as architectural blueprints and Building Information Modeling (BIM) data. The prior information provides a reference for the existing systems to match their observations against, significantly improving the accuracy of layout reconstruction. However, this can present problems regarding integrating prior information into the existing systems, as some systems require sophisticated algorithms to align the sensor data with prior models and to handle discrepancies between the as-built environment and the design plans. Additionally, the existing systems may not be able to fully utilize the prior information in real-time due to computational constraints.

There are various technical problems with the existing systems in the prior art. The existing systems rely on expensive sensors such as one or more LiDAR, which, while accurate, are not cost-effective for widespread use. Depth cameras, though more affordable, struggle with occlusions and have limited range and accuracy, which can lead to incomplete data capture. The combination of multiple sensors to improve coverage and accuracy adds complexity, requiring further calibration and increasing both cost and deployment difficulty. Additionally, the existing systems heavily depend on labeled training data, making them labor-intensive to set up. Even self-supervised approaches require diverse data and may fail in the environments that differ from their training conditions. Furthermore, integrating architectural blueprints into the existing systems is challenging, as it demands algorithms for alignment and real-time processing, which can exceed computational capabilities.

Therefore, there is a need for a system to address the aforementioned issues by developing a cost-effective solution that leverages one or more Red Green Blue (RGB) cameras, self-supervised learning, and existing three-dimensional (3D) models to provide accurate, real-time indoor layout reconstruction without the need for the expensive sensors.

### SUMMARY

In one general aspect, the instant disclosure describes a system having a processor and a memory in communication with the processor, where the memory includes executable instructions that, when executed by the processor, cause the system to perform multiple functions. These functions may include obtaining a first visual data set and generating a depth prior based on the first visual data set. The first visual data set can include visual imagery data and depth data. The depth prior can include geometric cues and semantic cues. These functions can include refining a depth prediction model based on the depth prior and generating a layout based on a refined depth prediction model. These functions can further include constructing a continuous three-dimensional map of the environment based on the layout and aggregated depth measurements.

In another general aspect, the instant disclosure describes a method of generating a three-dimensional map of an environment. This method may involve multiple steps. These steps may include obtaining a first visual data set and generating a depth prior based on the first visual data set. The first visual data set can include visual imagery data and depth data. The depth prior can include geometric cues and semantic cues. These steps can include refining a depth prediction model based on the depth prior and generating a layout based on a refined depth prediction model. These steps can further include constructing a continuous three-dimensional map of the environment based on the layout and aggregated depth measurements.

In yet another general aspect, the instant disclosure describes a non-transitory computer readable medium on which are stored instructions that when executed cause a programmable device to perform multiple functions. These functions may include obtaining a first visual data set and generating a depth prior based on the first visual data set. The first visual data set can include visual imagery data and depth data. The depth prior can include geometric cues and semantic cues. These functions can include refining a depth prediction model based on the depth prior and generating a layout based on a refined depth prediction model. These functions can further include constructing a continuous three-dimensional map of the environment based on the layout and aggregated depth measurements.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a flow diagram illustrating an example method for map generation.

FIG. 2 is a flow diagram illustrating an example method for map generation that includes an expanded initial data set.

FIG. 3 is a flow diagram illustrating an example method for map generation that includes object recognition and inferring occluded portions of the environment.

FIG. 4 is a flow diagram illustrating an example method for refining a depth prediction model shown in FIG. 1.

FIG. 5 is a flow diagram illustrating an example method for constructing a continuous three-dimensional map shown in FIG. 1.

FIG. 6 depicts an example architecture in which the system of the present embodiments may operate.

FIG. 7 is a block diagram showing an example system of the present embodiments along with its corresponding subsystems.

FIG. 8 is a block diagram showing an example map generating subsystem of the system shown in FIG. 7.

FIG. 9 depicts an example offline and online data flow with supervision of the systems and methods of the present embodiments.

FIG. 10 depicts an example data flow for generation of a three-dimensional map using RGB sensors, real time pose, and a model prior of the systems and methods of the present embodiments.

FIG. 11 is a block diagram showing an example software architecture, various portions of which may be used in conjunction with various hardware architectures herein described, which may implement any of the described features.

FIG. 12 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

### Technical Problem

In the field of environment mapping, in particular, indoor construction and renovation, accurate layout reconstruction is a challenge for applications ranging from facility management and security planning to autonomous robotic navigation. Conventional surveying and blueprint-based methods can be time-consuming, labor-intensive, and susceptible to human error. Modern indoor mapping systems have attempted to improve accuracy through advanced sensing technologies. LiDAR sensors, for example, have proven beneficial for depth measurement and producing precise three-dimensional maps. However, these sensors can be expensive, power-demanding, and physically bulky, thereby limiting their suitability in cost-sensitive and space-constrained environments. More affordable depth cameras provide an alternative but exhibit limited range, susceptibility to occlusions, and reduced accuracy in cluttered environments. Hybrid systems that combine multiple sensors improve data coverage but require complex calibration, increase deployment difficulty, and add significant cost. Prior art data-driven machine learning methods, supervised approaches, and incorporation of architectural blueprints and the like also face limitations. They can depend on large volumes of manually labeled training data, fail to generalize in unpredictable construction conditions, and require sophisticated alignment algorithms that impose computational demands beyond real-time capability. Accordingly, there exists a need for an improved indoor mapping system that achieves robust spatial understanding without excessive reliance on costly sensors, exhaustive training data, or complex blueprint integration.

### Technical Solution

The disclosed system addresses these challenges by employing a hybrid architecture that combines machine learning (ML), supervision, which can include self-supervision and pseudo supervision, and post-processing reasoning to optimize indoor mapping. The system captures timestamped field data using lightweight and affordable sensors, such as RGB cameras or depth cameras, which may provide only partial observations. To overcome incomplete visibility, the system applies machine learning models trained offline to extract both geometric and semantic information. Employed subsystems can perform 3D semantic segmentation on point cloud or depth data to identify structural elements such as walls, floors, and openings, and two-dimensional (2D) scene understanding, analyzing textures, objects, and color cues from imagery. These multimodal outputs can be processed through subystems that perform Bird's Eye View (BEV) projection for simplified reasoning, size estimation for dimensional accuracy, and layout reasoning to extrapolate unseen structures using architectural symmetry, continuity, and logical space arrangements. The system generates label attributes—including layout, size, and space type—that act as supervisory signals without requiring manual annotation. This supervision signal can link offline training with online deployment: offline procedures refine the model using generated labels, while online deployment uses the trained model for real-time prediction. As a result, the system transforms partial, noisy observations into a complete, semantically enriched 3D spatial map, adaptable to dynamic construction environments.

### Advantages of the Solution

The disclosed system offers multiple advantages over prior indoor mapping technologies. By minimizing dependence on LiDAR hardware, it reduces costs, power requirements, and physical bulk, enabling practical deployment on mobile robotic platforms such as drones or quadrupeds. Affordable sensors paired with intelligent ML processing achieve comparable accuracy at a fraction of the cost. A significant advantage is the system's robustness to occluded and incomplete data. Construction sites frequently involve cluttered conditions and partial visibility; by applying geometric reasoning and semantic inference, the system extrapolates unseen portions of the environment, producing continuous and reliable spatial reconstructions. The reliance on pseudo labels reduces the burden of creating manually annotated datasets, enabling scalable training and faster adaptation to new environments. Through the pseudo supervision signal, the system achieves continuous improvement: offline refinements feed into online deployment, ensuring adaptability rather than static performance. Additionally, the integration of semantic and contextual reasoning provides not only geometric precision but also functional understanding of spaces. This enrichment enables classification of environments into meaningful categories such as hallways, offices, or bathrooms—information valuable for facility management, navigation, and security applications. Finally, the architecture is computationally efficient. By limiting reliance on blueprint alignment while retaining the ability to incorporate prior information, the system avoids excessive processing demands and supports real-time operation, extending applicability across construction, maintenance, and autonomous robotics.

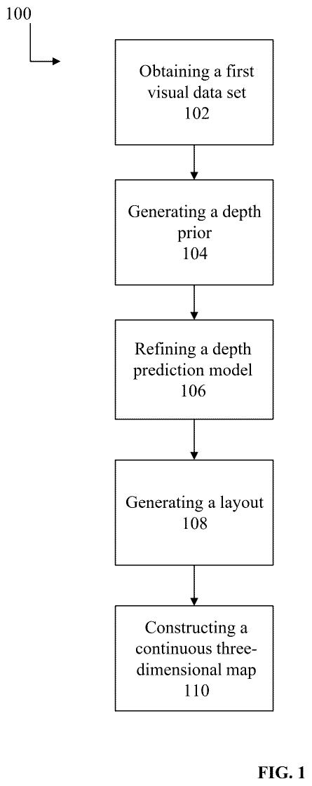

FIG. 1 is a flow diagram illustrating an example method 100 for map generation in accordance with the present disclosure. The method 100 can include obtaining a first visual data set (Step 102). The first visual data set can include both visual imagery data and depth data of the target environment. In some embodiments, depth data can be inferred based on aggregated and timestamped visual imagery data. This visual data set may be captured by one or more sensors, such as RGB cameras, stereo cameras, structured light sensors, or depth cameras. In some embodiments, LiDAR or time-of-flight sensors may also be incorporated to complement depth acquisition or may be excluded. The first visual data set provides discrete imagery data that can include high-level contextual cues, such as textures, colors, and object boundaries, while the depth data can convey geometric measurements corresponding to distances between the sensors and observed surfaces. Together, the visual and depth components form a multimodal dataset that can enable the system to capture both semantic and geometric attributes of the environment. This initial acquisition may occur in a dynamic setting, such as a construction site or indoor facility, where conditions frequently change. The first visual data set can be timestamped, which can aid in the first visual data set being sequentially processed and correlated. By consolidating diverse visual information into a unified dataset, the method provides a foundation for downstream processing tasks, including depth prior generation, model refinement, and layout construction.

The method 100 can include generating a depth prior (Step 104). The depth prior can be based on the first visual data set. The depth prior can be an intermediate representation that incorporates both geometric cues and semantic cues derived from the raw data. Geometric cues can include structural edges, vanishing points, planes, and volumetric outlines identifiable within the depth data. Semantic cues may include higher-level contextual indicators derived from the first visual data set, such as recognized walls, doors, or furnishings, which can aid in inferring spatial relationships and context. The depth prior can function as an informed baseline estimate of the environment's three-dimensional structure before detailed refinement. The depth prior can be input into a depth prediction network, which can include a neural network, which, in tandem with the raw RGB data, can be used to estimate depths within the environment. By merging geometry and semantics into a single representation, the depth prior enhances the ability of subsequent processing stages to generalize across diverse environments. This step reduces dependence on costly or high-resolution sensing by leveraging contextual reasoning to approximate missing information.

The method 100 can include refining a depth prediction model (Step 106). Based on generation of the depth prior, the method can refine a depth prediction model to more accurately reconstruct the three-dimensional environment. The refining step 106 can integrate the geometric and semantic cues contained in the depth prior, adjusting an initial depth prediction model's parameters to better capture environmental features. This can involve supervised, self-supervised, or pseudo-supervised training strategies. For example, pseudo label attributes derived from the prior—such as layout boundaries, object sizes, and space classifications—may serve as supervisory signals. These supervisory signals can inform the model, thereby enabling adaptation to real-world variations without requiring large volumes of manually annotated data. In some embodiments, iterative optimization techniques adjust the model weights to reduce errors between initial or previous predicted depth values and those provided by the prior. Additionally, refining step 106 can incorporate multi-modal consistency checks to ensure that predictions align with both visual imagery features and depth measurements. By iteratively updating the depth prediction model with these enhanced signals, the system develops greater robustness to noise, occlusion, and incomplete observations. Thereby, the refining step 106 can adapt pre-trained models to specific environments, such as cluttered construction sites or dynamically changing indoor layouts. The output can be a refined depth prediction model that balances computational efficiency with high spatial accuracy, thereby forming an input for layout generation.

The method 100 can include generating a layout (Step 108). Based on refinement of the depth prediction model, the method generates a layout of the environment. This step involves converting depth predictions into structured representations of spatial organization, such as room boundaries, corridors, partitions, and open areas. The layout can be informed by geometric reasoning, including symmetry detection, continuity of surfaces, and alignment of planar regions, as well as semantic reasoning, such as recognizing functional zones based on visual and contextual cues. For example, tiled surfaces may indicate bathrooms, while repetitive structural patterns may signify hallways or offices. Post-processing modules such as BEV projection, size estimation, and spatial reasoning can be employed to simplify and regularize the layout. This can convert raw depth outputs into a coherent top-down plan that reflects both the geometry and usage of spaces. The layout can also bridge observed and unobserved regions by extrapolating likely structures, thereby addressing gaps caused by occlusions or incomplete sensor coverage. In some embodiments, the method can integrate architectural priors or building information models to further validate or refine layout boundaries. By creating this structured intermediate representation, the system facilitates efficient downstream construction of a continuous three-dimensional map, while also providing a semantically enriched floor plan useful for navigation, monitoring, and management applications. In some embodiments, generating the layout can include generation of a top-down BEV representation. This can inform the method to anticipate likely structural features even where sensor data may be incomplete due to occlusions or limited visibility.

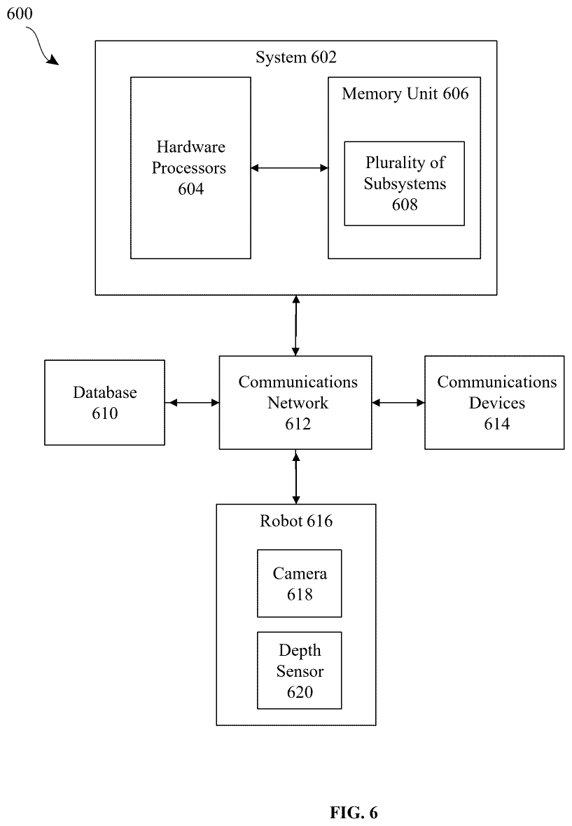

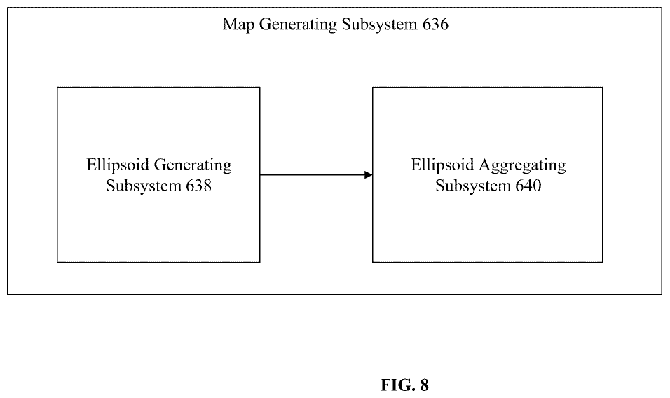

The method 100 can include constructing a continuous three-dimensional map of the environment (Step 110). The constructing a continuous three-dimensional map of the environment can be based on the generated layout and aggregated depth measurements. This step can include fusing sequentially captured data into a unified three-dimensional representation that is spatially consistent across the entire environment. The layout can act as a structural framework that can guide the placement and alignment of depth measurements to ensure continuity. Aggregated depth measurements can be integrated into this framework, with discrepancies corrected through geometric alignment and semantic reasoning. The resulting three-dimensional map can be continuous, meaning it avoids disjointed or fragmented segments, and accurately represents both the geometry and functional attributes of spaces. The map may be stored as a dense point cloud, a mesh, a continuous three-dimensional function such as that formed by three-dimensional Gaussian splatting, described further with regard to FIG. 5 and FIG. 8, or a hybrid data structure enriched with semantic labels identifying space types, object classes, and dimensional attributes. The map can aid applications such as robotic navigation, safety monitoring, and construction verification, by provision of global spatial coherence. In some embodiments, the system operates in real time, updating the 3D map dynamically as new observations are collected, adding to the aggregated depth measurements. This aids adaptability in evolving environments, such as active construction sites. The final output provides a comprehensive, accurate, and semantically meaningful reconstruction of the environment, enabling improved decision-making across diverse indoor mapping applications.

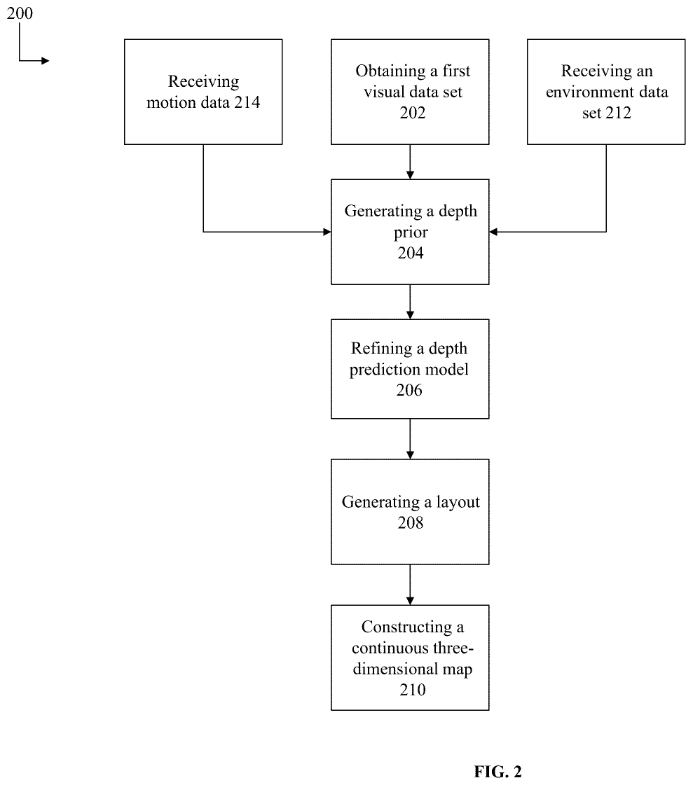

FIG. 2 is a flow diagram illustrating an example method 200 for map generation that includes an expanded initial data set in accordance with the present disclosure. Steps 202, 204, 206, 208, and 210 can be identical to those described with regard to FIG. 1, and for the sake of brevity, are not described further here.

The method 200 can include receiving an environment data set (Step 212). The environment data set can include building plans, architectural blueprints, and Building Information Models (BIM). This environment data set can provide prior knowledge of the structural layout and intended design of an indoor space. Such prior information can serve as a reference point for improving the accuracy and completeness of subsequent depth and layout predictions. For instance, building plans and blueprints may identify room boundaries, corridor placements, wall alignments, and doorway positions that can be cross-referenced against sensor data. BIM files may provide an even richer set of data, incorporating not only geometric and spatial details but also semantic cues such as material types and functional classifications of spaces. The received environment data set can be processed into a machine-readable form and aligned with the captured visual and depth data. In cases where discrepancies exist between as-built conditions and the design documents, the system may employ alignment algorithms to reconcile the observed environment with the prior models. By incorporating this environment data, the method can utilize high-level design intent to augment incomplete sensor observations, reduce uncertainty, and enhance spatial reasoning. This integration can inform depth priors and layout generation, thereby aiding in their more accurate reflection of both observed and predicted features of the environment.

The method 200 can include receiving motion data (Step 214). The motion data can include movement data, inertial data, or combinations thereof. Motion data may be obtained from onboard inertial measurement units (IMUs), accelerometers, gyroscopes, or odometry sensors integrated with the sensing platform. This data can provide information about the position, orientation, and trajectory of the sensor platform over time. By incorporating motion data, the system can improve spatial alignment across sequentially captured visual and depth datasets, reducing drift and inconsistencies in the mapping process. For example, inertial readings may be fused with camera observations to track the motion of a robotic platform as it traverses a construction site, ensuring that visual data collected at different timestamps can be properly registered into a coherent three-dimensional representation. Additionally, motion data can enhance the accuracy of depth priors by contextualizing observations with respect to the platform's movement, enabling better handling of occlusions or areas captured from varying viewpoints. In some embodiments, motion data may also support dynamic reasoning, allowing the system to distinguish between stationary structural elements and transient objects or obstacles. The integration of motion data thereby aids the foundation upon which the depth prediction model and layout generation are built, thereby improving the accuracy and efficiency in constructing the three-dimensional across the entire environment.

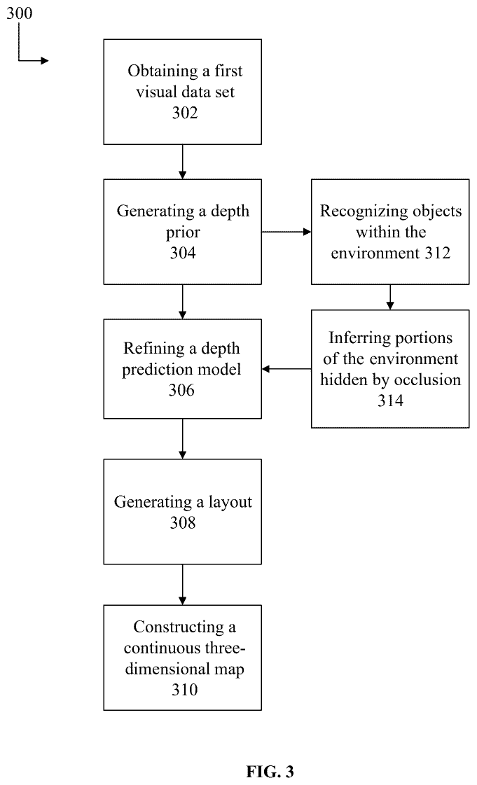

FIG. 3 is a flow diagram illustrating an example method 300 for map generation that includes object recognition and inferring occluded portions of the environment in accordance with the present disclosure. Steps 302, 304, 306, 308, and 310 can be identical to those described with regard to FIG. 1 and FIG. 2, and for the sake of brevity are not described further here.

The method 300 can include recognizing objects within the environment (Step 312). Recognizing 312 objects within the environment can be based on semantic cues and geometric cues extracted from the first visual data set. Semantic cues may include color patterns, surface textures, and contextual features derived from two-dimensional imagery, which can enable the system to differentiate between categories of objects such as walls, doors, windows, or furnishings. Geometric cues may include depth measurements, edge contours, surface normals, and volumetric shapes detected within the three-dimensional data. Utilizing both semantic cues and geometric cues, the method can employ a multimodal recognition process that enhances accuracy and robustness, even in complex or cluttered environments. Recognition may be performed using machine learning models trained on diverse object categories, with the semantic and geometric cues serving as inputs to classification and segmentation pipelines. Recognized objects can provide functional context to the mapping process. For example, detecting a doorway indicates a potential passage between rooms, while recognizing tables or chairs may help identify a space as an office. This step contributes to higher-level scene understanding by enriching the raw geometric map with semantic labels that reflect both structure and function. The recognition of objects thus informs other steps, such as depth model refinement and layout generation, by correlating spatial predictions to real-world, meaningful features.

The method 300 can include inferring portions of the environment hidden by occlusion (Step 314). Inferring portions of the environment that are hidden by occlusion can be based on the semantic cues and geometric cues. Occlusions can occur when objects, walls, or construction materials obstruct a given sensors' line of sight, thereby creating gaps in the collected visual or depth data. To address this, the method applies reasoning strategies that extrapolate from observed information to predict the likely structure of occluded areas. Geometric cues, such as symmetry, continuity of planes, and alignment of edges, can enable the system to extend visible surfaces into hidden regions. Semantic cues provide contextual knowledge: for example, recognizing one side of a doorway allows the system to infer the presence of a corresponding opening on the opposite side, or detecting partial tiled surfaces may indicate the presence of a complete bathroom space. Machine learning models may further support inference by drawing on prior knowledge of typical architectural patterns and spatial arrangements. By filling in occluded areas with predicted structures, the system reduces discontinuities and produces a more complete representation of the environment. This inferred information can be incorporated into the depth prediction model during refinement, thereby enabling that the layout and continuous three-dimensional map more accurately reflect the full spatial context, even in areas that were not directly observed by the sensors.

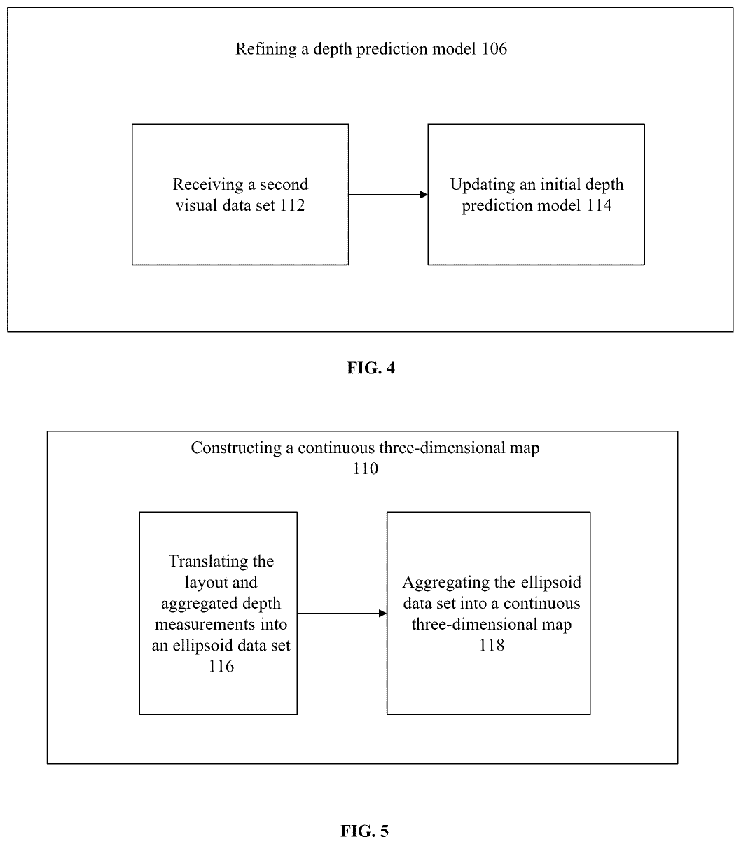

FIG. 4 is a flow diagram illustrating an example method for refining a depth prediction model 106 shown in FIG. 1. Refining the depth prediction model 106 can include receiving a second visual data set (Step 112). The second visual data set can be received via at least one depth sensor and at least one camera. This second visual data set can supplement the initial observations obtained during the first stage of data collection, providing additional views, updated measurements, or expanded coverage of the environment. The depth sensor, which may include stereo cameras, structured light sensors, or time-of-flight systems, generates distance information by detecting disparities or return times of emitted signals. The accompanying camera captures RGB imagery, offering contextual features such as textures, colors, and object outlines. Together, these modalities can form a multimodal dataset that can aid both geometric precision and semantic understanding, thereby providing semantic cues and geometric cues. In practice, the second data set may include previously unseen areas or improved observations of regions that were partially occluded, noisy, or inaccurately captured in an initial or previous dataset, which can include the first visual data set. By incorporating this supplementary dataset, the system increases the diversity and reliability of its training signals, thereby aiding the refinement process. The sequential, and in some embodiments, iterative, nature of the second dataset can also facilitate temporal reasoning, allowing the system to align multiple perspectives and improve continuity across frames. Thus, receiving the second visual data set (Step 112) can aid the refinement process by providing expanded, multimodal observations that better represent real-world, observed conditions.

Refining the depth prediction model 106 can further include updating an initial depth prediction model (Step 114). Based on receipt of a second or subsequent visual data set, the system can update an initial depth prediction model to produce a refined depth prediction model. The initial depth prediction model, which may have been trained using the first dataset and corresponding depth prior, can provide a baseline for estimation of scene depth. However, its accuracy may be limited by incomplete coverage, sensor noise, or restricted generalization to new conditions. By incorporating the second visual data set, the method performs iterative refinement of the model's parameters. In some embodiments, labels generated from the second dataset—such as predicted room boundaries, structural outlines, and dimensional estimates—are used as supervisory signals. Through the use of a supervisory signal including a supervisory data set, which can include, for example, layout boundaries, object sizes, and space classifications, which can be generated by the system, the system can more efficiently incorporate the aggregated visual data to produce the refined model. These labels allow the system to self-correct and adapt without requiring extensive manual annotations. Model updating may involve backpropagation within a neural network, optimization of weight parameters, or integration of additional feature layers that account for semantic cues captured in the imagery. The refinement process thereby can reduce prediction errors, enhance robustness to occlusions, and improve consistency across diverse environmental contexts. Thereby, the refined depth prediction model can effectively estimate three-dimensional structures and can generalize more effectively to dynamic indoor environments. This updated model can serve as the basis for generating accurate layouts and constructing a continuous three-dimensional map of the environment.

FIG. 5 is a flow diagram illustrating an example method for constructing a continuous three-dimensional map 110 shown in FIG. 1. Constructing a continuous three-dimensional map can include translating the generated layout and aggregated depth measurements into an ellipsoid data set (Step 116). The ellipsoid data set can include a plurality of ellipsoids, each parameterized by position data and covariance data, which together describe the spatial distribution of observed points within the environment. The translation process can include aligning the aggregated depth measurements with the structural framework defined by the generated layout. Observed surfaces, boundaries, and volumetric regions are represented not as discrete points but as ellipsoidal kernels, where the centroid can encode the spatial position and the covariance matrix encodes orientation and uncertainty. This ellipsoidal representation enables the system to model surfaces and volumes in a probabilistic and continuous fashion, rather than relying solely on sparse or irregular point clouds. By employing ellipsoids, the system accommodates noise, occlusions, and incomplete measurements, since covariance captures uncertainty across multiple viewing perspectives. Furthermore, this representation forms the basis for three-dimensional Gaussian splatting, where ellipsoids are assumed to be Gaussian kernels and projected into continuous space. Each ellipsoid contributes smoothly to the overall density function, ensuring that the subsequent map generation reflects both the observed data and inferred continuity across unobserved regions. Thus, the ellipsoid data set provides a robust and semantically aligned intermediate representation for continuous map construction.

Constructing a continuous three-dimensional map can further include aggregating the ellipsoid data set into a continuous three-dimensional map (Step 118). Based on translation into the ellipsoid data set, the method can include aggregating the ellipsoids into a continuous three-dimensional function, thereby constructing the three-dimensional map of the environment. Each ellipsoid can function as a Gaussian kernel that contributes to a probabilistic spatial density function. Through three-dimensional Gaussian splatting, as described further with regard to FIG. 8, the ellipsoids can be projected into a volumetric domain, where overlapping regions are smoothly combined. This aggregation produces a continuous function f(x), where x is a point in 3-dimensional space, that assigns a density or occupancy likelihood to every point in space, enabling the representation of both observed structures and inferred surfaces with seamless continuity. Unlike discrete point cloud methods, which yield sparse and fragmented reconstructions, Gaussian splatting integrates local observations into globally coherent spatial models. The aggregation process also leverages covariance data to control the anisotropy of each ellipsoid, allowing elongated or directionally biased kernels to capture structural features such as walls, beams, or corridors. The result can be a smooth volumetric representation that preserves fine structural detail while bridging gaps caused by occlusions or incomplete sensing. The continuous three-dimensional function can be further rendered into a semantic map suitable for downstream applications such as robotic navigation, facility management, or construction monitoring. By aggregating the ellipsoid data set through three-dimensional Gaussian splatting, the method achieves a robust, continuous three-dimensional map of the environment.

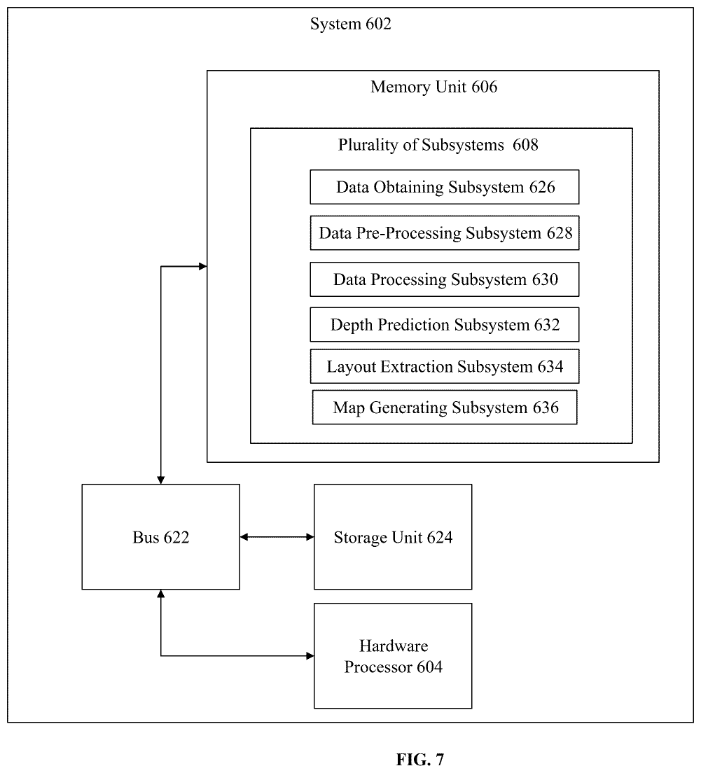

FIG. 6 depicts an example architecture 600 in which the system 602 of the present embodiments may operate. The architecture 600 can include a system 602, database 610, communications network 612, communications devices 614, and robot 616. The system 602 can include hardware processors 604 and a memory unit 606.

The architecture 600 can include a system 602 that includes a hardware processor 202. The one or more hardware processors 604, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 604 may also include embedded controllers, such as generic or programmable logic devices or arrays, application-specific integrated circuits, single-chip computers, and the like.

The memory unit 606 can include a plurality of subsystems 608. The memory unit 606 may be the non-transitory volatile memory and the non-volatile memory. The memory unit 606 may be coupled to communicate with the one or more hardware processors 604, such as being a computer-readable storage medium. The one or more hardware processors 604 may execute machine-readable instructions and/or source code stored in the memory unit 606. A variety of machine-readable instructions may be stored in and accessed from the memory unit 606. The memory unit 606 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 606 can include the plurality of subsystems 608.

The plurality of subsystems 608 can be stored in the form of machine-readable instructions on any of the above-mentioned storage media and may be in communication with and executed by the one or more hardware processors 604. A computer system (standalone, client or server computer system) configured by an application may constitute a “module” (or “subsystem”) that is configured and operated to perform certain operations. In one embodiment, the “module” or “subsystem” may be implemented mechanically or electronically, so a module can include dedicated circuitry or logic that is permanently configured (within a special-purpose processor) to perform certain operations. In another embodiment, a “module” or “subsystem” may also include programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

The architecture 600 can include a database 610. The database 610 may include, but not limited to, storing, and managing data related to visual odometry data, RGB) data, Red Green Blue Depth (RGBD) data, and timestamp information, which were previously obtained via at least one camera and at least one depth sensor. The database 610 serves as a central repository for all relevant data, enabling efficient data retrieval and analysis to support decision-making processes. The database 610 can include semantic information for inclusion within the continuous three-dimensional map and thereby facilitates the semantic-based robotic navigation in the scene. Furthermore, the database 610 may manage user access controls, configuration settings, and system logs, providing a comprehensive solution for data management and security within the network architecture.

The architecture 600 can include a communications network 612. Communications network 612 can include one or more communications networks 210 and can be, but not limited to, a wired communication network, a wireless communication network, or a combination of wired communication networks and wireless communications networks. The wired communication network may include, but not be limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may include, but not be limited to, at least one of: wireless fidelity (wi-fi), cellular networks (including 4G (fourth generation), 5G (fifth generation), and 6G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like. The one or more communication networks 210 can be configured to facilitate data exchange and communication between the system 602 and the database 610 for real-time data analysis.

The architecture 600 can include communications devices 614. The communications devices 614 can be one or more communication devices 212 and may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, display interface panels, control panels, human machine interface panels, liquid crystal display (LCD) screens, light-emitting diode (LED) screens, and the like. The one or more communication devices 212 can be configured to function as an intermediate unit between the system 602 and one or more users. The one or more communication devices 212 can be equipped with a user interface that allows the one or more users to interact with the system 602. The user interface may include graphical displays, touchscreens, voice recognition, and other input/output mechanisms that facilitate easy access to data and control functions. Any other instructions may be provided by one or more users to the system 602 via the user interface.

The architecture 600 can include a robot 616, which can be one or more robots 616. The one or more robots 616 can be, but are not necessarily restricted to, at least one of a: quadruped, wheeled robot, biped, drone, and the like. The robot 616 can communicate with the system 602, communications devices 614, and database 610 via the communications network 612.

The robot 616 can include at least one camera 618 and at least one depth sensor 620. The camera 618 and depth sensor 620 are configured to track the movement of the one or more robots 616, assisting the one or more robots 616 in understanding its position and orientation within the complex scene. The camera 618 can be one or more RGB cameras and the depth sensor 620, which can be one or more depth sensors, are configured to capture both color information and depth data, which indicates how far away objects are in the environment.

Those of ordinary skilled in the art will appreciate that the hardware depicted in FIG. 6 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 602 as is unique to the present disclosure or necessary for an understanding of the present disclosure is depicted and described. The remainder of the construction and operation of the system 602 may conform to any of the various current implementations and practices that were known in the art.

FIG. 7 is a block diagram showing an example system 602 of the present embodiments along with its corresponding subsystems. The system 602 can include a memory unit 606, bus 622, storage unit 624, and hardware processor 604. The memory unit 606 can include a plurality of subsystems 608, which can include a data obtaining subsystem 626, data pre-processing subsystem 628, data processing subsystem 630, data prediction subsystem 632, layout extraction subsystem 634, and map generating subsystem 636. 606

The system 602 can include a memory unit 606. The memory unit 606 can be identical to the memory unit 606 described in FIG. 6, and for the sake of brevity, is no described further here.

The system 602 can include a bus 622. The system bus 604 can function as a central conduit for data transfer and communication between the one or more hardware processors 604, the memory unit 606, and the storage unit 624. The system bus 622 facilitates the efficient exchange of information and instructions, enabling a coordinated operation of the system 602. The system bus 622 may be implemented using various technologies, including, but not limited to, parallel buses, serial buses, or high-speed data transfer interfaces such as, but not limited to, at least one of a: universal serial bus (USB), peripheral component interconnect express (PCIe), and similar standards.

The system can include a storage unit 624. The storage unit 624 may be a cloud storage or the database 610, such as those shown in FIG. 6. The storage unit 624 may store, but not limited to, recommended course of action sequences dynamically generated by the system 602. These action sequences can include data-obtaining, data processing, instruction interpreting, robot navigation, and the like. The storage unit 624 may be any kind of database such as, but not limited to, relational databases, dedicated databases, dynamic databases, monetized databases, scalable databases, cloud databases, distributed databases, any other databases, graph databases, vector databases, and a combination thereof.

The system can include a data obtaining subsystem. The data obtaining subsystem 626 can be configured to obtain sensor data from one or more sensors. The one or more sensors may include, but are not necessarily restricted to, at least one of: one or more RGB cameras, one or more depth sensors, one or more LiDAR sensors, and the like. The data obtaining subsystem 626 can exclude LiDAR sensors. The one or more sensors may capture visual imagery, depth information, point clouds, and other relevant environmental data.

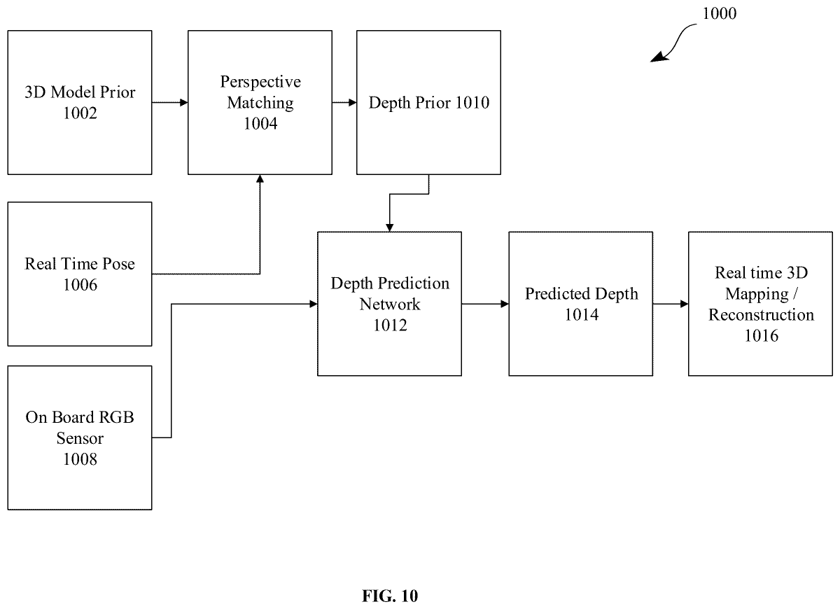

The data obtaining subsystem 626 can also configured to receive building data through a user interface. For instance, the one or more users may input the building data such as building plans, blueprints, BIM models, and other relevant 3D models through the user interface. This feature can enhance the system's 602 flexibility by allowing it to incorporate human knowledge and existing documentation into its analysis. The data obtaining subsystem 626 can also be configured to receive motion data, as shown in FIG. 10, to determine its position and orientation within the environment. The data obtaining subsystem 626 can receive inputs from wheel encoders, which track the movement of the one or more robots 616 by measuring rotations of wheels. One or more Inertial Measurement Unit (IMU) sensors provide data on acceleration and angular velocity. The motion data can compute an orientation or a pose of the one or more robots 616, which can include the three-dimensional position and the orientation in the environment.

The system 602 can include a data pre-processing subsystem 628. The data pre-processing subsystem 628 can be configured to match images from the one or more RGB cameras with the building data to generate a depth prior that reflects the comparison between the images and the building data. The data-preprocessing subsystem 628 can be configured to process the raw sensor data to identify and segment walls within the environment.

The system 602 can include a data processing subsystem 630. The data processing subsystem 630 can be configured to enhance indoor layout reconstruction. The data processing subsystem 630 can address challenges such as occlusions and limited sensor coverage by using geometric cues and semantic cues to infer and reconstruct unseen parts of the environment. The data-processing subsystem 630 can be configured to take partial sensor data, the geometric cues, and semantic information as inputs to produce enhanced layout data that includes inferred hidden structures. The data processing subsystem 630 can be configured to incorporate high-level visual information, including object recognition and scene context from the images. The data-processing subsystem 630 can be configured to refine 3D layout data by integrating the high-level visual information, resulting in a more accurate and contextually enriched representation of the environment.

The system 602 can include a depth prediction subsystem 632. The depth prediction subsystem can be configured with a depth prediction model, which can be an initial estimate of the environment. The depth prediction subsystem 632 can be configured to predict depth information for each discrete pixel in the first visual data set by utilizing both the raw images and the depth prior generated by the data-preprocessing subsystem 628. An output obtained is detailed, pixel-level depth data that represents a spatial structure of the environment. The system 602 can also enhance the depth prediction model by using data collected from the RGB camera and depth sensor, and one or more LiDAR sensors, which can also be excluded. The system 602 can train the depth prediction model through a self-supervised approach, which involves inputting observed image and depth data, as well as depth predictions, to refine the depth prediction model. As a result, the depth prediction subsystem 632 can refine the depth prediction model with more accurate depth estimations.

The system 602 can include a layout extraction subsystem 634. The layout extraction subsystem 634 can be configured to transform and reconstruct indoor layouts. The layout extraction subsystem 634 can simplify an extraction process by projecting segmented three-dimensional layout data into a top-down BEV, which provides a comprehensive, two-dimensional perspective of the environment's layout. The layout extraction subsystem 634 can take segmented wall, edge, and object data as input and utilize it to produce a BEV layout projection that facilitates easier analysis and visualization. The layout extraction subsystem 634 can extrapolate and reconstruct the complete indoor layout by integrating partial three-dimensional observations and predicted depth information. The output of the layout extraction subsystem 634 is a fully estimated indoor layout that represents the entire environment.

The system 602 can include a map generating subsystem 636. The map generating subsystem 636 can be configured to combine and aggregate depth measurements from the discrete visual data sets and the fully estimated indoor layout into a cohesive, continuous real-time three-dimensional map. The three-dimensional map represents a spatial arrangement of the environment. Subsequently, the map generating subsystem 636 can enhance the three-dimensional map by applying advanced procedures such as Gaussian Splatting. The Gaussian Splatting is used in 3D map reconstruction where depth points are represented as Gaussian distributions, allowing for smooth and continuous surfaces. The map generating subsystem 636 can leverage prior model data to refine and ensure the global consistency of the three-dimensional map, correcting any discrepancies and improving the accuracy of the spatial representation. The result is the highly refined, continuous three-dimensional map that accurately reflects the environment with improved global coherence.

Though few components and a plurality of subsystems 608 are disclosed in FIG. 7, there may be additional components and subsystems which is not shown, such as, but not limited to, ports, routers, repeaters, firewall devices, network devices, the database 610, network attached storage devices, assets, machinery, instruments, facility equipment, emergency management devices, image capturing devices, any other devices, and combination thereof. The person skilled in the art should not be limiting the components/subsystems shown in FIG. 7. Although FIG. 7 illustrates the system 602, and the one or more communication devices 614 connected to the database 610, one skilled in the art can envision that the system 602, and the one or more communication devices 614 may be connected to several user devices located at various locations and several databases via the one or more communication network 612.

FIG. 8 is a block diagram showing an example map generating subsystem 636 of the system shown in FIG. 7. The map generating subsystem 636 can include an ellipsoid generating subsystem 638. The first visual data set, second visual data set, and any aggregated visual data sets can include or consist of inherently discrete data. The inherently discrete data may include sensor measurements, from a camera or plurality of camera and a depth sensor or plurality of depth sensors, a set of points in three dimensional space x₁, x₂, x₃, . . . xₙR³. Stored as pure points, they can be expressed as a sum of Dirac delta functions f(x)=Σδ(x−xᵢ) where δ(x−xᵢ)=1 if x=xᵢ and 0 otherwise. This representation is inherently discrete; it is zero everywhere except at the measured points. It is not continuous, as between the points, f(x)=0.

Utilizing the layout and the visual data, the ellipsoid generating subsystem 638 can translate the discrete into a set of Gaussian ellipsoids. This can be done by correlating the visual data to the layout and replacing the delta functions of the discrete data visual data set with a smooth spatial kernel, such as a Gaussian ellipsoid. The Gaussian ellipsoid can be defined by

$$N ( x \vert {μ}_{i} , {\sum }_{i} ) = exp [ - ( 1 / 2 ) ( x - {μ}_{i}^{T} {\sum }_{i}^{- 1} ( x - {μ}_{i} ) ) ] {/ [ ( 2 {π}^{3} ) \vert {\sum }_{i} \vert ]}^{∧} ( 1 / 2 )$$

where μᵢ is the center of the Gaussian in three-dimensional space (based on the discrete sensor measurement location) and Σᵢ is a covariance matrix that defines the shape and spread of the ellipsoid. The exponential term decays smoothly with distance from the center.

The map generating subsystem can include an ellipsoid aggregating subsystem 640. A continuous, three-dimensional map of the environment can be generated based on the set of Gaussian ellipsoids by replacing the three-dimensional discrete data with the generated ellipsoids by defining

$$f ( x ) = {\sum }_{i = 1}^{n} ( {w}_{i} * N ( x \vert μ i , \sum i ) ) ,$$

where wᵢ is a weight that can encode color intensity, opacity, or some other semantic information. Thereby, each term x is defined in f(x) explicitly, even if x is not a measurement location. Further, the Gaussian is defined for all x in the three-dimensional space. Blending of the Gaussians can be achieved by summation, and the sum is continuous as the sum of continuous functions is inherently continuous. Further, there are no gaps in the map, as between any two discrete measurement points used as input, the Gaussian kernels overlap and fill the space.

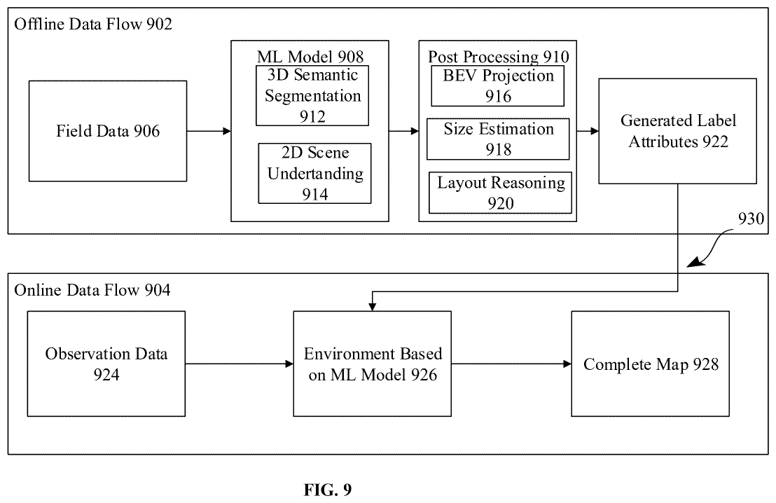

FIG. 9 depicts an example offline 902 and online 904 data flow with supervision 930 of the systems and methods of the present embodiments. The system 602 can leverage both offline data flow 902 and online data flow 904, with a supervision signal, which can be a pseudo-supervision signal, acting as a bridge between the two. This hybrid approach allows for insights gained during training to be continually or iteratively used to enhance the accuracy of real-time spatial predictions when the system is deployed in the field.

The data flow can begin with field data 906. Field data 906 can be acquired via a database or one or more sensors, such as LiDAR, RGB cameras, depth sensors, or platforms equipped with stereo vision. This raw data can be tied to a timestamp rollout (t⁰, t¹, t²), which can organize the sequential data into discrete time stamps. Each timestamp can represent a snapshot of the environment from a given sensor position. At this stage, the system is dealing with partial and incomplete views of the environment. Occlusions, sensor limitations, and restricted movement pathways mean that only portions of walls, ceilings, and floors may be visible at each timestep.

The field data 906 can be utilized by at least one ML model 908. The ML model 908 can include three-dimensional semantic segmentation 912. The raw point clouds or depth maps can be recognized by the model 908 segmented into meaningful classes such as walls, doors, windows, and structural components. Semantic segmentation provides a categorical label for each observed point, helping the system understand what each part of the environment represents. The ML model 908 can also include two-dimensional scene understanding 914. In parallel to the segmentation 912, two-dimensional features can be extracted from camera imagery. These include textures, object contours, and spatial relationships recognizable via digital images. By aligning the 2D information with the 3D data, the system achieves a multimodal representation that aids accuracy. Together, these models can transform unstructured sensor data into semantically rich environmental representations. This marks the transition from raw sensing to machine-interpreted spatial knowledge.

The outputs of the ML models can proceed to post processing 910, which can refine the predictions. This can include BEV projection 916, in which segmented and labeled three-dimensional data can be projected into a top-down, two-dimensional layout representation. This can simplify geometric reasoning, allowing the system to detect room boundaries and spaces therebetween.

Post processing 910 can include size estimation 918. Size estimation 918 can include objects, walls, and rooms being measured in three dimensions to estimate their true scale. This step aids in verifying that the spatial predictions align with real-world dimensions.

Post processing 910 can include layout reasoning 920. Layout reasoning can utilize geometric and semantic cues to infer an overall room and corridor layout. Layout reasoning can include such assumptions as symmetry, common architectural patters, and continuity constraints to extrapolate beyond what is directly visible to aid in prediction of unseen portions of the environment. For instance, if one side of a hallway is visible, the system may infer the presence of a parallel wall on the other side, even if it is occluded.

Based on the post processing 910, the offline data flow 902 can proceed to generated label attributes 922, which can be pseudo label attributes, being attached to the data. These label attributes can include labeling of data in terms of geometric information such as size and dimension but can also include semantic information. This semantic information can include layout attributes (such as walls, openings, corridors, room structures, etc.) and classification of space type, such as hallways, offices, bathrooms, storage rooms, etc. These labels can aid in supervision of the system by simplifying the classification of observed data.

A supervision signal 930, which can be a pseudo supervision signal, can link the offline 902 and online 904 data flows. Offline procedures involve extensive model training, using collected and generated labels to refine model accuracy. Online procedures involve real-time deployment in active construction environments. The supervision signal enables the system to continuously improve: offline training enhances online predictions, and online observations provide fresh data that can retrain the models. The supervision signal 930 can be generated by the system to iteratively refine the model with supervision data. This supervision data can include, for example, layout boundaries, object sizes, and space classifications. These labels allow the system to self-correct and adapt without requiring extensive manual annotations. This iterative relationship allows the system to continuously utilize accumulated knowledge while also adapting to new environments.

In the online 904 portion, the trained ML model is deployed in the field, which can be on a platform such as a robot. This robot can capture real time observation data 924, which can include partial observations of the environment, constrained by their movement paths and sensor perspectives. This can include information related to the robot's position and orientation, as well as sensor data from an RGB camera, which can be used to form aggregated depth data. Even with this limited, discrete input, the environment based on the ML model 926 can estimate the complete spatial structure. It does so by utilizing geometric cues, which can include shapes, lines, planes, and volumetric structures from raw depth maps, and semantic cues, which can include knowledge of object categories and architectural elements. It can also include layout reasoning, which can include use of assumptions about symmetry, standard room arrangements, and adjacency patterns to fill in missing details, and high-level visual cues, which can include recognition of objects, textures, and colors that suggest functional context, such as tiles indicating a bathroom or desks indicating an office.

Based on the trained environment, a complete map 928 reflecting complete spatial prediction and understanding can be obtained. Unlike raw point clouds, this representation incorporates semantic understanding, logical extrapolations, and accurate dimensional estimates. The map can be a continuous three-dimensional map that can, support construction progress monitoring, assist in navigation of autonomous robots, provide real-time digital twins of construction sites, or enable safety and compliance inspections. The data flow can thus convert partial, noisy, and incomplete observations into a coherent, richly annotated 3D model of the indoor environment.

FIG. 10 depicts an example data flow 1000 for generation of a three-dimensional map using RGB sensors 1008, real time pose 1006, and a model prior 1002 of the systems and methods of the present embodiments. Data flow can begin with a 3D model prior 1002, which can include an architectural or design-based reference of the environment. This model may originate from BIM, CAD designs, or previously captured spatial data. The 3D model prior 1002 can serve as a high-level template containing geometric and semantic details of the structure, such as wall locations, room boundaries, and door placements. By leveraging this reference, the system can align real-time observations with expected layouts, enabling more accurate and efficient mapping. The prior also supplies contextual cues for reasoning about occluded or partially observed areas, aiding continuity in the depth estimation and reconstruction process.

The real-time pose 1006 includes information to determine the position and orientation of the robot in the environment. This pose estimation may be derived from inertial measurement units (IMUs), odometry sensors, or visual-inertial algorithms combining RGB imagery and motion data. Real-time pose 1006 information enables the system to localize the robot accurately, synchronize sensor data, and maintain spatial coherence between sequential frames. Thereby, the system can integrate observations into a unified three-dimensional map.

The on-board RGB sensor 1008 can capture visual imagery of the environment in real time. This imagery can include color, texture, and structural details that can complement depth estimations. The RGB data gathered by the sensor 1008 supports semantic reasoning, such as recognizing functional elements like doors, furniture, or stairways. Coupled with geometric cues, this imagery allows the system to enhance spatial reasoning and produce data that is context-aware.

Perspective matching 1004 can include aligns real-time observations from the RGB sensor and pose estimation with the 3D model prior. By correlating current viewpoints with the 3D model prior 1002, the system can generate a coherent spatial alignment that aligns observations and accurately registers them within the broader environment. This can account for differences between design data and as-built conditions by dynamically adjusting the alignment process, and can serve an input for generating a depth prior.

The depth prior 1010 can represent a synthesized estimate of the environment's geometric structure, created by combining perspective-matched imagery 1004, pose data 1006, and the 3D model prior 1002. This prior incorporates both semantic and geometric cues, providing an informed baseline for depth estimation. It can include estimation of structural elements even in areas of occlusion or limited visibility, thereby aiding ensuring that the subsequent depth prediction starts with a contextually accurate and geometrically consistent representation.

The depth prediction network 1012 can refine the depth prior 1010 using real-time sensor data 1008 to produce accurate depth estimations. This network 1012, typically a trained machine learning model, integrates RGB imagery, pose information, and prior data to enhance precision. It adapts to variations in the environment, correcting for discrepancies between design intent and as-built conditions, and generating depth predictions that are robust even in cluttered or dynamic settings.

The depth prediction network 1012 can produce a predicted depth map 1014. The predicted depth output provides a depth map representing the environment in real time. The predicted depth map can include both local and global geometric features, enabling accurate reconstruction of walls, objects, and other structural elements. The predicted depth 1014 can serves as the critical input for the mapping and reconstruction stage, aiding spatial continuity and accuracy throughout the environment.

Based on the predicted depth map 1014, the data flow can proceed to real-time 3D mapping and reconstruction 1016, where the predicted depth maps are aggregated into a continuous, semantically rich three-dimensional representation of the environment. This reconstruction accounts for both observed and inferred regions, providing a coherent map suitable for navigation, monitoring, and analysis. By maintaining real-time performance, the system supports dynamic environments, allowing continuous updates as new data becomes available. In this way, using RGB cameras alone and with no LiDAR input, the system can reconstruct the depth and geometric data that LiDAR gives using cameras only. In industrial applications, blueprints, 3D models, BIM, etc. are often available. By leveraging blueprints, 3D models, and BIM as a prior, a three-dimensional geometric reconstruction from RGB only can be performed with much higher accuracy.

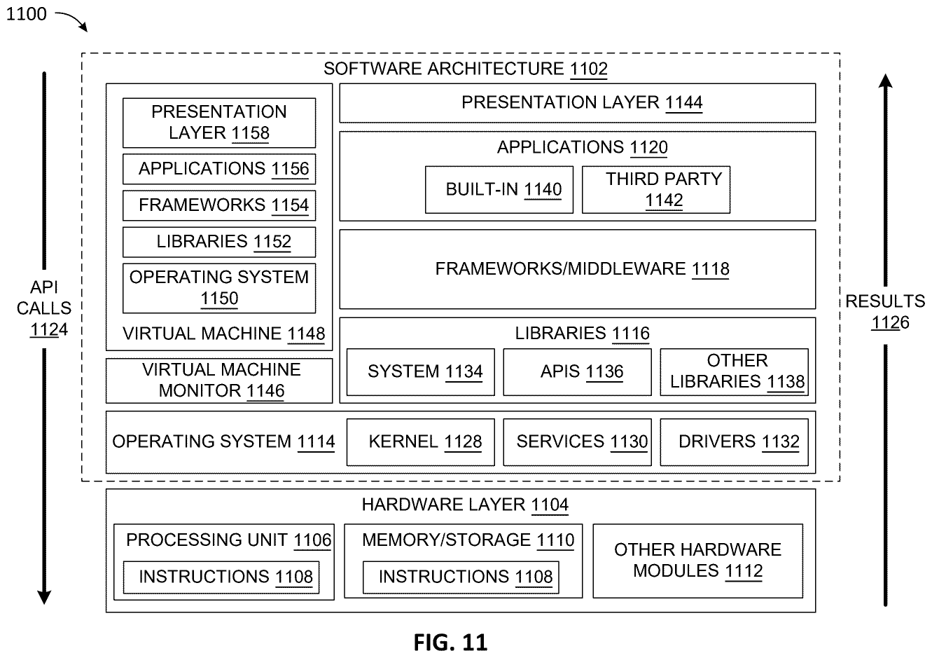

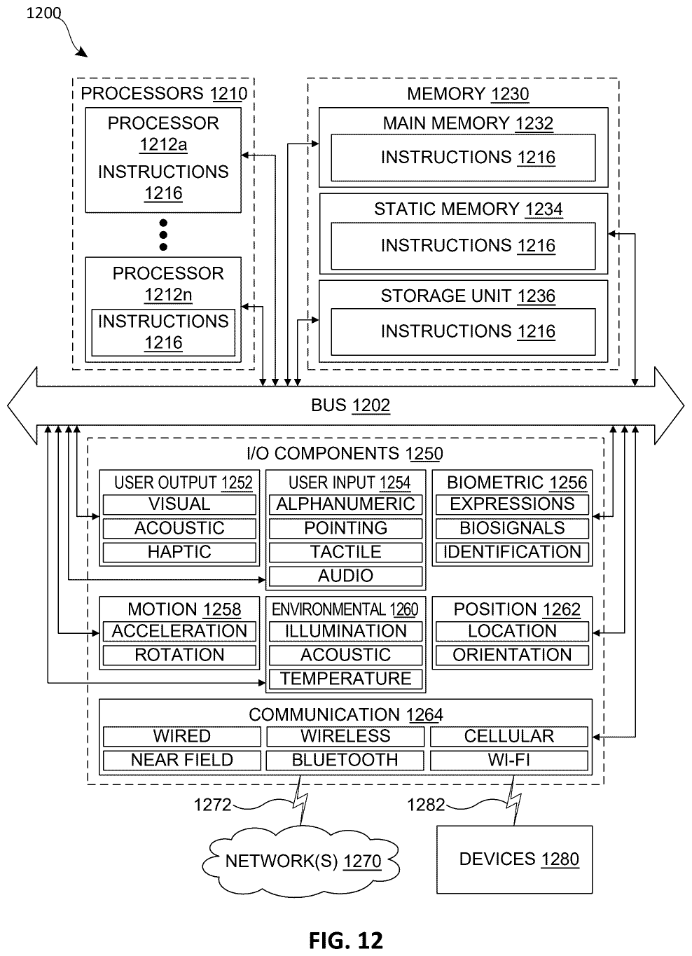

FIG. 11 is a block diagram 1100 illustrating an example software architecture 1102, various portions of which may be used in conjunction with various hardware architectures herein described, which may implement any of the above-described features. FIG. 11 is a non-limiting example of a software architecture, and it will be appreciated that many other architectures may be implemented to facilitate the functionality described herein. The software architecture 1102 may execute on hardware such as a machine 1200 of FIG. 12 that includes, among other things, processors 1210, memory/storage, and input/output (I/O) components 1250. A representative hardware layer 1104 is illustrated and can represent, for example, the machine 1200 of FIG. 12. The representative hardware layer 1104 includes a processing unit 1106 and associated executable instructions 1108. The executable instructions 1108 represent executable instructions of the software architecture 1102, including implementation of the methods, modules and so forth described herein. The hardware layer 1104 also includes a memory/storage 1110, which also includes the executable instructions 1108 and accompanying data. The hardware layer 1104 may also include other hardware modules 1112. Instructions 1108 held by processing unit 1106 may be portions of instructions 1108 held by the memory/storage 1110.

The example software architecture 1102 may be conceptualized as layers, each providing various functionality. For example, the software architecture 1102 may include layers and components such as an operating system (OS) 1114, libraries 1116, frameworks/middleware 1118, applications 1120, and a presentation layer 1144. Operationally, the applications 1120 and/or other components within the layers may invoke API calls 1124 to other layers and receive corresponding results 1126. The layers illustrated are representative in nature and other software architectures may include additional or different layers. For example, some mobile or special purpose operating systems may not provide the frameworks/middleware 1118.

The OS 1114 may manage hardware resources and provide common services. The OS 1114 may include, for example, a kernel 1128, services 1130, and drivers 1132. The kernel 1128 may act as an abstraction layer between the hardware layer 1104 and other software layers. For example, the kernel 1128 may be responsible for memory management, processor management (for example, scheduling), component management, networking, security settings, and so on. The services 1130 may provide other common services for the other software layers. The drivers 1132 may be responsible for controlling or interfacing with the underlying hardware layer 1104. For instance, the drivers 1132 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1116 may provide a common infrastructure that may be used by the applications 1120 and/or other components and/or layers. The libraries 1116 typically provide functionality for use by other software modules to perform tasks, rather than interacting directly with the OS 1114. The libraries 1116 may include system libraries 1134 (for example, C standard library) that may provide functions such as memory allocation, string manipulation, file operations. In addition, the libraries 1116 may include API libraries 1136 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1116 may also include a wide variety of other libraries 1138 to provide many functions for applications 1120 and other software modules.

The frameworks/middleware 1118 provide a higher-level common infrastructure that may be used by the applications 1120 and/or other software modules. For example, the frameworks/middleware 1118 may provide various graphic user interface (GUI) functions, high-level resource management, or high-level location services. The frameworks/middleware 1118 may provide a broad spectrum of other APIs for applications 1120 and/or other software modules.

The applications 1120 include built-in applications 1140 and/or third-party applications 1142. Examples of built-in applications 1140 may include, but are not limited to, a contacts application, a browser application, a location application, a media application, a messaging application, and/or a game application. Third-party applications 1142 may include any applications developed by an entity other than the vendor of the particular platform. The applications 1120 may use functions available via OS 1114, libraries 1116, frameworks/middleware 1118, and presentation layer 1144 to create user interfaces to interact with users.

Some software architectures use virtual machines, as illustrated by a virtual machine 1148. The virtual machine 1148 provides an execution environment where applications/modules can execute as if they were executing on a hardware machine (such as the machine 1200 of FIG. 12, for example). The virtual machine 1148 may be hosted by a host OS (for example, OS 1114) or hypervisor, and may have a virtual machine monitor 1146 which manages operation of the virtual machine 1148 and interoperation with the host operating system. A software architecture, which may be different from software architecture 1102 outside of the virtual machine, executes within the virtual machine 1148 such as an OS 1150, libraries 1152, frameworks 1154, applications 1156, and/or a presentation layer 1158.

FIG. 12 is a block diagram illustrating components of an example machine 1200 configured to read instructions from a machine-readable medium (for example, a machine-readable storage medium) and perform any of the features described herein. The example machine 1200 is in a form of a computer system, within which instructions 1216 (for example, in the form of software components) for causing the machine 1200 to perform any of the features described herein may be executed. As such, the instructions 1216 may be used to implement modules or components described herein. The instructions 1216 cause unprogrammed and/or unconfigured machine 1200 to operate as a particular machine configured to carry out the described features. The machine 1200 may be configured to operate as a standalone device or may be coupled (for example, networked) to other machines. In a networked deployment, the machine 1200 may operate in the capacity of a server machine or a client machine in a server-client network environment, or as a node in a peer-to-peer or distributed network environment. Machine 1200 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1200 is illustrated, the term “machine” includes a collection of machines that individually or jointly execute the instructions 1216.

The machine 1200 may include processors 1210, memory/storage 1230, and I/O components 1250, which may be communicatively coupled via, for example, a bus 1202. The bus 1202 may include multiple buses coupling various elements of machine 1200 via various bus technologies and protocols. In an example, the processors 1210 (including, for example, a central processing unit (CPU), a graphics processing unit (GPU), a digital signal processor (DSP), an ASIC, or a suitable combination thereof) may include one or more processors 1212a to 1212n that may execute the instructions 1216 and process data. In some examples, one or more processors 1210 may execute instructions provided or identified by one or more other processors 1210. The term “processor” includes a multicore processor including cores that may execute instructions contemporaneously. Although FIG. 12 shows multiple processors, the machine 1200 may include a single processor with a single core, a single processor with multiple cores (for example, a multicore processor), multiple processors each with a single core, multiple processors each with multiple cores, or any combination thereof. In some examples, the machine 1200 may include multiple processors distributed among multiple machines.

The memory/storage 1230 may include a main memory 1232, a static memory 1234, or other memory, and a storage unit 1236, both accessible to the processors 1210 such as via the bus 1202. The storage unit 1236 and memory 1232, 1234 store instructions 1216 embodying any one or more of the functions described herein. The memory/storage 1230 may also store temporary, intermediate, and/or long-term data for processors 1210. The instructions 1216 may also reside, completely or partially, within the memory 1232, 1234, within the storage unit 1236, within at least one of the processors 1210 (for example, within a command buffer or cache memory), within memory at least one of I/O components 1250, or any suitable combination thereof, during execution thereof. Accordingly, the memory 1232, 1234, the storage unit 1236, memory in processors 1210, and memory in I/O components 1250 are examples of machine-readable media.

As used herein, “machine-readable medium” refers to a device able to temporarily or permanently store instructions and data that cause machine 1200 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1216) for execution by a machine 1200 such that the instructions, when executed by one or more processors 1210 of the machine 1200, cause the machine 1200 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1250 may include a wide variety of hardware components adapted to receive input, provide output, produce output, transmit information, exchange information, capture measurements, and so on. The specific I/O components 1250 included in a particular machine will depend on the type and/or function of the machine. For example, mobile devices such as mobile phones may include a touch input device, whereas a headless server or IoT device may not include such a touch input device. The particular examples of I/O components illustrated in FIG. 12 are in no way limiting, and other types of components may be included in machine 1200. The grouping of I/O components 1250 are merely for simplifying this discussion, and the grouping is in no way limiting. In various examples, the I/O components 1250 may include user output components 1252 and user input components 1254. User output components 1252 may include, for example, display components for displaying information (for example, a liquid crystal display (LCD) or a projector), acoustic components (for example, speakers), haptic components (for example, a vibratory motor or force-feedback device), and/or other signal generators. User input components 1254 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1250 may include biometric components 1256, motion components 1258, environmental components 1260, and/or position components 1262, among a wide array of other physical sensor components. The biometric components 1256 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1258 may include, for example, acceleration sensors (for example, an accelerometer) and rotation sensors (for example, a gyroscope). The environmental components 1260 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1262 may include, for example, location sensors (for example, a Global Position System (GPS) receiver), altitude sensors (for example, an air pressure sensor from which altitude may be derived), and/or orientation sensors (for example, magnetometers).

The I/O components 1250 may include communication components 1264, implementing a wide variety of technologies operable to couple the machine 1200 to network(s) 1270 and/or device(s) 1280 via respective communicative couplings 1272 and 1282. The communication components 1264 may include one or more network interface components or other suitable devices to interface with the network(s) 1270. The communication components 1264 may include, for example, components adapted to provide wired communication, wireless communication, cellular communication, Near Field Communication (NFC), Bluetooth communication, Wi-Fi, and/or communication via other modalities. The device(s) 1280 may include other machines or various peripheral devices (for example, coupled via USB).

In some examples, the communication components 1264 may detect identifiers or include components adapted to detect identifiers. For example, the communication components 1264 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1264, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A method of generating a three-dimensional map of an environment, comprising:
obtaining a first visual data set, wherein the first visual data set includes visual imagery data and depth data;
generating a depth prior based on the first visual data set, wherein the depth prior includes geometric cues and semantic cues;
refining a depth prediction model based on the depth prior;
generating a layout based on a refined depth prediction model; and
constructing a continuous three-dimensional map of the environment based on the layout and aggregated depth measurements.

2. The method of claim 1, further comprising:
receiving an environment data set including at least one of building plans, blueprints, and building information models; and
receiving motion data including at least one of movement data and inertial data.

3. The method of claim 1, further comprising:
recognizing objects within the environment based on the semantic cues and the geometric cues; and
inferring portions of the environment hidden by occlusion based on the semantic cues and the geometric cues.

4. The method of claim 1, wherein refining a depth prediction model includes:
receiving a second visual data set via at least one depth sensor and at least one camera; and
updating an initial depth prediction model based on the second visual data set and a supervisory data set containing at least one item selected from the group consisting of layout boundaries, object sizes, and space classifications to produce the refined depth prediction model.

5. The method of claim 1, wherein generating the layout includes combining the refined depth prediction model and three-dimensional observation data.

6. The method of claim 1, wherein constructing a continuous three-dimensional map of the environment includes translating the layout and aggregated depth measurements into an ellipsoid data set comprising a plurality of ellipsoids, wherein each ellipsoid in the ellipsoid data set comprises position data and covariance data.

7. The method of claim 6, wherein translating the layout and aggregated depth measurements includes aggregating the ellipsoid data set into a continuous three-dimensional function.

8. A system comprising:
a processor; and
a memory in communication with the processor, the memory comprising executable instructions that, when executed by the processor, cause the system to perform functions of:
obtaining a first visual data set, wherein the first visual data set includes visual imagery data and depth data;
generating a depth prior based on the first visual data set, wherein the depth prior includes geometric cues and semantic cues;
refining a depth prediction model based on the depth prior;
generating a layout based on a refined depth prediction model; and
constructing a continuous three-dimensional map of an environment based on the layout and aggregated depth measurements.

9. The system of claim 8, wherein the memory further comprises executable instructions that, when executed by the processor, cause the system to perform functions of:
receiving an environment data set, including at least one of building plans, blueprints, and building information models; and
receiving motion data, including at least one of movement data and inertial data.

10. The system of claim 8, wherein the memory further comprises executable instructions that, when executed by the processor, cause the system to perform functions of:
recognizing objects within the environment based on the semantic cues and the geometric cues; and
inferring portions of the environment hidden by occlusion based on the semantic cues and the geometric cues.

11. The system of claim 8, wherein refining a depth prediction model includes receiving a second visual data set via at least one depth sensor and at least one camera; and
updating an initial depth prediction model based on the second visual data set and a supervisory data set containing at least one item selected from the group consisting of layout boundaries, object sizes, and space classifications.

12. The system of claim 8, wherein generating the layout includes combining the refined depth prediction model and three-dimensional observation data.

13. The system of claim 8, wherein constructing a continuous three-dimensional map of the environment includes translating the layout and aggregated depth measurements into an ellipsoid data set comprising a plurality of ellipsoids, wherein each ellipsoid in the ellipsoid data set comprises position data and covariance data.

14. The system of claim 13, wherein translating the layout and aggregated depth measurements includes aggregating the ellipsoid data set into a continuous three-dimensional function.

15. A non-transitory computer readable medium on which are stored instructions that when executed cause a programmable device to:
obtain a first visual data set, wherein the visual data set includes visual imagery data and depth data;
generate a depth prior based on the first visual data set, wherein the depth prior includes geometric cues and semantic cues;
refine a depth prediction model based on the depth prior;
generate a layout based on a refined depth prediction model; and
construct a continuous three-dimensional map of an environment based on the layout and aggregated depth measurements.

16. The non-transitory computer readable medium of claim 15, wherein the instructions when executed further cause the programmable device to:
receive an environment data set, wherein the environment data set includes at least one of building plans, blueprints, and building information models; and
receive motion data, wherein the motion data comprises at least one of movement data and inertial data.

17. The non-transitory computer readable medium of claim 15, wherein the instructions when executed further cause the programmable device to:
recognize objects within the environment based on the semantic cues and the geometric cues; and
infer portions of the environment hidden by occlusion based on the semantic cues and the geometric cues.

18. The non-transitory computer readable medium of claim 15, wherein the refined depth prediction model is based on a second visual data set received via at least one depth sensor and at least one camera; and
updating an initial depth prediction model based on the second visual data set and a supervisory data set containing at least one item selected from the group consisting of layout boundaries, object sizes, and space classifications.

19. The non-transitory computer readable medium of claim 15, wherein the layout is based on combining the refined depth prediction model and three-dimensional observation data.

20. The non-transitory computer readable medium of claim 15, wherein the continuous three-dimensional map of the environment includes a continuous three-dimensional function based on aggregation of an ellipsoid data set including a plurality of ellipsoids, wherein each ellipsoid in the ellipsoid data set comprises position data and covariance data.
